(19) United States
(12) Patent Application Publication
(10) Pub. No.: US 2026/0367376 A1
(43) Pub. Date: Nov. 19, 2026

(54) OPTICAL MICROSCOPE AND LIGHT INCIDENCE ANGLE ADJUSTMENT METHOD THEREFOR

(71) Applicant: UNIST(ULSAN NATIONAL INSTITUTE OF SCIENCE AND TECHNOLOGY), Ulsan (KR)

(72) Inventors: Chung Hun PARK, Ulsan (KR); Yundon JEONG, Ulsan (KR)

(21) Appl. No.: 19/126,274

(22) PCT Filed: Nov. 3, 2023
(86) PCT No.: PCT/KR2023/017489

§ 371 Date: May 1, 2025

(30) Foreign Application Priority Data
Nov. 9, 2022 (KR) 10-2022-0149093

(51) Int. Cl. G02B 21/00; G01N 21/64

(52) U.S. Cl. CPC G02B 21/0032; G01N 21/6458

(57) ABSTRACT

Provided is an optical microscope capable of outputting incident light of incidence angles that differ by observation area of a sample. The optical microscope uses grid patterns corresponding to each of at least one observation area of a sample, so as to adjust the incidence angles of light emitted from a light-emitting unit, and can output, onto the sample, at least one incident light having an adjusted incident angle.

### TECHNICAL FIELD

The present disclosure relates to an optical microscope capable of outputting incident lights with different incident angles for respective observation regions of a sample and measuring fluorescence or scattered light emitted from the sample, and a method for controlling the incident angles of the incident lights of the optical microscope.

This study is related to the research project “Brain activity mapping using a holographic in-vivo two-photon microscope for simultaneous 3D volume measurement” (No. 1711170194) supported by the National Research Foundation of Korea with funding from the Ministry of Science and ICT (government of Korea) in 2020.

### BACKGROUND ART

In order to observe the fluorescence signal of a sample, such as a target of observation, using a microscope, it is required to provide illumination, i.e., light capable of exciting the fluorescent particles in the sample to the sample.

In commonly used fluorescence microscopes, light is provided to penetrate the entire area of a sample, which causes the sample to be exposed to excessive light. Accordingly, when samples with many cells or tissues are exposed to light, there is a problem that the samples are damaged by phototoxicity, and in particular, organic-based samples are subject to a photobleaching effect, where the fluorescence signal gradually weakens the longer the organic-based sample is exposed to light.

Recently, total internal reflection fluorescence microscopy has been developed, which utilizes an evanescent field that occurs when light undergoes total reflection at the interface between two different media with different refractive indices as the light provided to the sample.

The evanescent field has the characteristic that its penetration depth varies by adjusting the angle of incidence of the light output to the sample. In addition, since the intensity of the evanescent field decreases exponentially as it moves away from the reflective surface, the evanescent field has the characteristic that the penetration depth of light into the sample is very shallow, on the order of several hundred nanometers.

Due to the characteristics of the evanescent field, total internal reflection fluorescence microscopy allows light to penetrate only fluorescent particles on the surface of the sample, thereby minimizing damage to the sample due to phototoxicity or photobleaching effects.

However, conventional total internal reflection fluorescence microscopes generate an evanescent field by adjusting a single incident angle for the light output to the sample, making it difficult to accurately observe multiple fluorescent particles located at different depths in the sample.

To address this, conventional total reflection fluorescence microscopes employ a method of sequentially adjusting the angle of incidence of light output to the sample to vary the penetration depth of the light into the sample. However, this method complicates the configuration of the total internal reflection fluorescence microscope, and requires image post-processing to acquire and observe sample images for each light output sequentially to the sample, and then synthesize them into a single image, so that it becomes difficult to acquire and observe images of the sample in real time.

### DETAILED DESCRIPTION OF INVENTION

### Technical Problems

The present disclosure provides an optical microscope capable of outputting incident light with different incident angles for respective observation regions of a sample and measuring fluorescence or scattered light emitted from the sample, and a method for controlling the light incident angle thereof.

### Technical Solution

In accordance with one embodiment of the present disclosure, an optical microscope comprises: a light emitting unit that generates light; an incident angle control unit that adjusts an incident angle of light emitted from the light emitting unit using a grid pattern corresponding to each of one or more observation regions of a sample, and outputs one or more incident lights with adjusted incident angles; and an optical unit that outputs the one or more incident lights to the sample.

Further, the incident angle control unit may include: a wavefront control unit that diffracts the light at different angles using the grid pattern displayed on one surface to output multiple diffracted lights; a filter unit that includes a plurality of slits and selectively passes the multiple diffracted lights output from the wavefront control unit through the plurality of slits to output the one or more incident lights respectively corresponding to the one or more observation regions; and an operation control unit that calculates a light penetration depth for each of the one or more observation regions of the sample, and generates the grid pattern corresponding to each of the one or more observation regions based on the calculated light penetration depth and outputs the grid pattern to the wavefront control unit.

Further, the operation control unit may control a display spacing of the grid pattern displayed on the wavefront control unit.

Further, the operation control unit may adjust the incident angle of each of the one or more incident lights by adjusting a position of each of the plurality of slits.

Further, the incident angle control unit may further include a plurality of lenses one of which is disposed between the wavefront control unit and the filter unit to focus the multiple diffracted lights output from the wavefront control unit at different locations in the filter unit, and another one of which is disposed behind of the filter unit to focus the one or more incident lights output through the plurality of slits at different locations in the optical unit.

Further, the incident angle control unit may include at least one of a MEMS (micro electro mechanical systems) deformable mirror, a liquid crystal spatial light modulator, a digital micromirror, and a phase plate.

Further, the one or more incident lights may include: a first incident light having a first incident angle smaller than a critical angle between the optical section and the sample; a second incident light having a second incident angle smaller than the critical angle and larger than the first incident angle; and a third incident light having a third incident angle larger than the critical angle.

Further, a penetration depth of the first incident light into the sample may be greater than a penetration depth of each of the second incident light and the third incident light, and the penetration depth of the second incident light into the sample may be greater than the penetration depth of the third incident light.

Further, the optical unit may simultaneously output the first incident light, the second incident light, and the third incident light to the sample.

Further, the optical unit may sequentially output the first incident light, the second incident light, and the third incident light to the sample.

Further, a method for controlling a light incident angle of an optical microscope, the method may comprise: calculating a light penetration depth for each of one or more observation regions of a sample; generating a grid pattern corresponding to each of the one or more observation regions based on the calculated light penetration depth; outputting multiple diffracted lights by diffracting light emitted from a light emitting unit at different angles based on the grid pattern; and outputting one or more incident lights by selectively passing some of the multiple diffracted lights corresponding to the one or more observation regions.

Further, the outputting multiple diffracted lights may include: displaying the grid pattern corresponding to each of the one or more observation regions on one surface of a wavefront control unit; and outputting the multiple diffracted lights by controlling a display spacing of the grid pattern.

Further, the outputting one or more incident lights may include controlling an incident angle of each of the one or more incident lights by controlling a position of each of a plurality of slits in a filter unit.

### Effect of Invention

The optical microscope according to the present disclosure generates a plurality of incident lights with different incident angles for respective observation regions of the sample from a single light output from the light emitting unit and outputs them to the sample, thereby controlling the excitation depth of each incident light into the sample to be different.

Accordingly, when the optical microscope of the present disclosure is applied to a total internal reflection fluorescence microscope, by providing a plurality of incident lights with different incident angles to the sample, fluorescent particles located at different depths in the sample can be selectively observed, so that sample images including fluorescent signals emitted from the fluorescent particles can be processed at high speed in real time.

### BRIEF DESCRIPTION OF THE DRAWINGS

FIG. 1 is a block diagram showing an optical microscope according to an embodiment of the present disclosure.

FIG. 2 is a diagram showing an optical path in the optical microscope according to the embodiment of the present disclosure.

FIGS. 3 to 6 are diagrams showing examples of the operation of the optical microscope of the present disclosure.

FIG. 7 is a flowchart illustrating a method for controlling the light incident angle of the optical microscope, according to an embodiment of the present disclosure.

### BEST MODE FOR CARRYING OUT THE INVENTION

The advantages and features of the present disclosure, and the methods for achieving them, will become apparent with reference to the embodiments described in detail below in conjunction with the accompanying drawings. However, the present disclosure is not limited to the embodiments disclosed below, but may be implemented in various different forms, and these embodiments are provided only to ensure a complete disclosure of the present disclosure and to fully inform those of ordinary skill in the art to which the present disclosure pertains of the scope of the disclosure, and the present disclosure is defined only by the scope of the claims.

In describing the embodiments of the present disclosure, detailed descriptions of known functions or configurations will be omitted if it is judged that such descriptions could unnecessarily obscure the gist of the present disclosure. In addition, the terms described below are defined in consideration of functions in the embodiments of the present disclosure, and these may vary depending on the intentions or practices of users or operators. Therefore, the definitions should be interpreted based on the overall content of the present specification.

Hereinafter, preferred embodiments of the present disclosure will be described in detail with reference to the accompanying drawings.

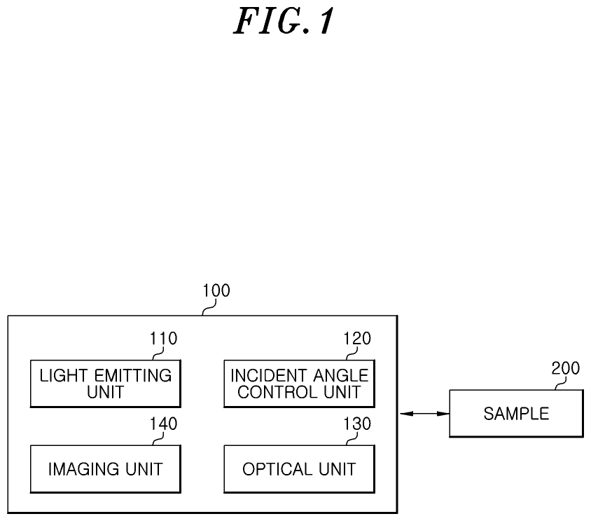

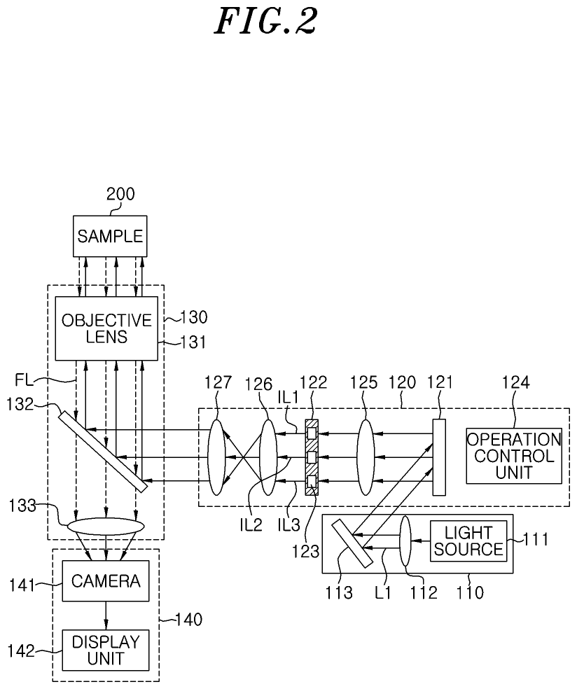

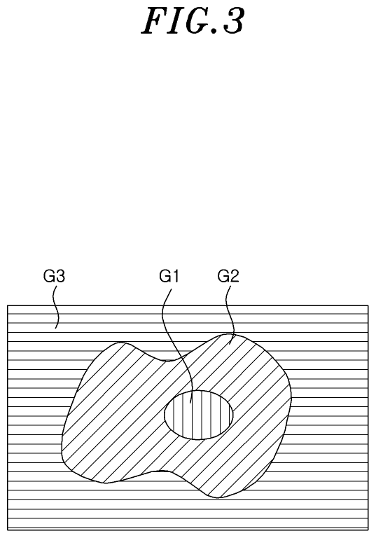

FIG. 1 is a block diagram showing an optical microscope according to an embodiment of the present disclosure, FIG. 2 is a diagram showing an optical path in the optical microscope according to the embodiment of the present disclosure, and FIGS. 3 to 6 are diagrams showing examples of the operation of the optical microscope of the present disclosure.

Hereinafter, for convenience of explanation, a total internal reflection fluorescence microscope that measures multiple fluorescence emitted from various depths of a sample among optical microscopes will be described as an example. However, the present disclosure is not limited thereto, and the present disclosure may also be applied to an optical microscope that measures multiple scattered lights emitted from a sample.

Referring to FIGS. 1 and 2, an optical microscope 100 of the present embodiment provides light to a sample 200 at different incident angles, and accordingly receives and images one or more fluorescent signals FL emitted from the sample 200, thereby obtaining information about the sample 200. The optical microscope 100 may include a light emitting unit 110, an incident angle control unit 120, an optical unit 130, and an imaging unit 140.

The light emitting unit 110 may include a light source 111, a collimating lens 112, and a reflective mirror 113.

The light source 111 can generate and output light that is capable of penetrating the sample 200. The light generated from the light source 111 may be excitation light L1 that can excite fluorescent particles in the sample 200, but the present disclosure is not limited thereto.

The collimating lens 112 can make the excitation light L1 output from the light source 111 parallel along the direction of propagation without being dispersed.

The reflective mirror 113 can reflect the excitation light L1 that has passed through the collimating lens 112 at a predetermined angle. The excitation light L1 reflected by the reflective mirror 113 can be provided to the incident angle control unit 120.

The incident angle control unit 120 can generate and output a plurality of incident lights IL1, IL2, IL3 having different incident angles from the excitation light L1 output from the light emitting unit 110. In this case, the incident angle may refer to the angle at which light is incident on the sample 200 through the optical unit 130 to be described later.

The incident angle control unit 120 may include a wavefront control unit 121, a filter unit 122, an operation control unit 124, and a plurality of lenses, e.g., a first lens 125, a second lens 126, and a third lens 127.

The wavefront control unit 121 can generate and output multiple diffracted lights from the excitation light L1. The wavefront control unit 121 can diffract the excitation light L1 at a plurality of angles by using one or more grid patterns displayed on one surface, e.g., an incident surface on which the excitation light L1 output from the light emitting unit 110 is incident, and output multiple diffracted lights accordingly.

The wavefront control unit 121 may include at least one of a MEMS (micro electro mechanical systems) deformable mirror, a liquid crystal spatial light modulator, a digital micromirror, and a phase plate.

In this case, one or more grid patterns displayed on the wavefront control unit 121 may respectively correspond to a plurality of observation regions of the sample 200, for example, regions to be observed at different depths with respect to the sample 200, and the grid patterns corresponding to the respective observation regions may have different pattern shapes.

Referring to FIG. 3, one or more grid patterns may include a first grid pattern G1, a second grid pattern G2, and a third grid pattern G3, each having a different pattern shape. These grid patterns may correspond to different observation regions among a plurality of observation regions of the sample 200.

For example, the first grid pattern G1 may be a pattern corresponding to a central region of the sample 200, for example, a region where the nucleus of a cell is located. The second grid pattern G2 may be a pattern corresponding to a region surrounding the central region of the sample 200, for example, the cell region excluding the nucleus. In addition, the third grid pattern G3 may be a pattern corresponding to a remaining region excluding the cell region of the sample 200.

Each of the first grid pattern G1, the second grid pattern G2, and the third grid pattern G3 may be generated by the operation control unit 124 to be described later, and provided to the wavefront control unit 121. In this case, the operation control unit 124 may control the display spacing of one or more grid patterns, and accordingly, the wavefront control unit 121 may display the first grid pattern G1 to the third grid pattern G3 simultaneously or may display the first grid pattern G1 to the third grid pattern G3 sequentially.

Referring again to FIG. 2, the first lens 125 may be disposed between the wavefront control unit 121 and the filter unit 122. The first lens 125 may focus multiple diffracted lights output from the wavefront control unit 121 on different positions of the filter unit 122.

The filter unit 122 may selectively pass diffracted light at specific positions among the multiple diffracted lights incident through the first lens 125 to output one or more incident lights, for example, a first incident light IL1, a second incident light IL2, and a third incident light IL3.

In this case, since the multiple diffracted lights incident on the filter unit 122 from the wavefront control unit 121 are lights generated by one or more grid patterns displayed on the wavefront control unit 121, each of the first incident light IL1 to the third incident light IL3 output from the filter unit 122 may be light corresponding to each of the plurality of observation regions of the sample 200 according to the grid pattern that generated the corresponding diffracted light. Accordingly, the first incident light IL1 to the third incident light IL3 may be output to different regions of the sample 200 through the optical unit 130 to be described later.

In addition, the first incident light IL1 to the third incident light IL3 may have different incident angles depending on the diffraction angles of the corresponding diffracted lights. In this case, the incident angle of the first incident light IL1 may be smaller than the incident angles of the second incident light IL2 and the third incident light IL3, and the incident angle of the second incident light IL2 may be smaller than the incident angle of the third incident light IL3. Further, the incident angles of the first incident light IL1 and the second incident light IL2 may be smaller than a critical angle, and the incident angle of the third incident light IL3 may be larger than the critical angle. In this case, the critical angle may refer to the angle of incidence at which when the light output from the optical unit 130 to be described later is incident on the sample 200, the refracted angle becomes 90 degrees, causing total reflection.

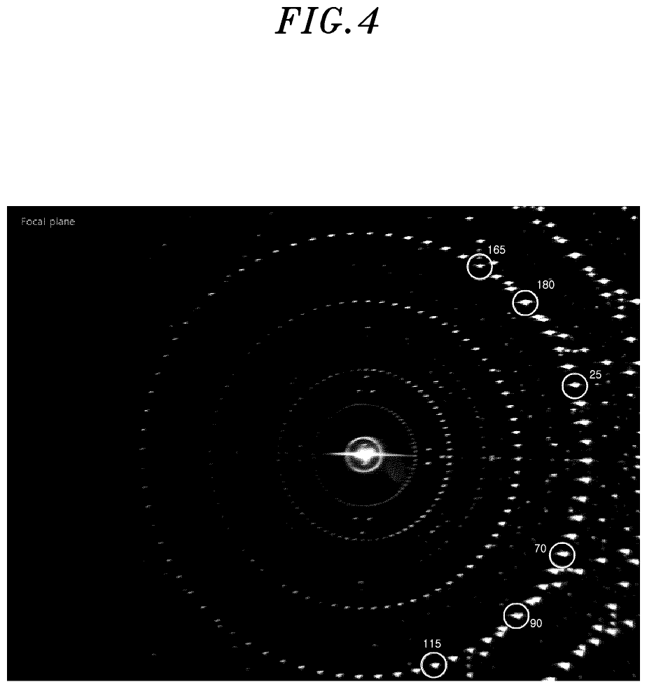

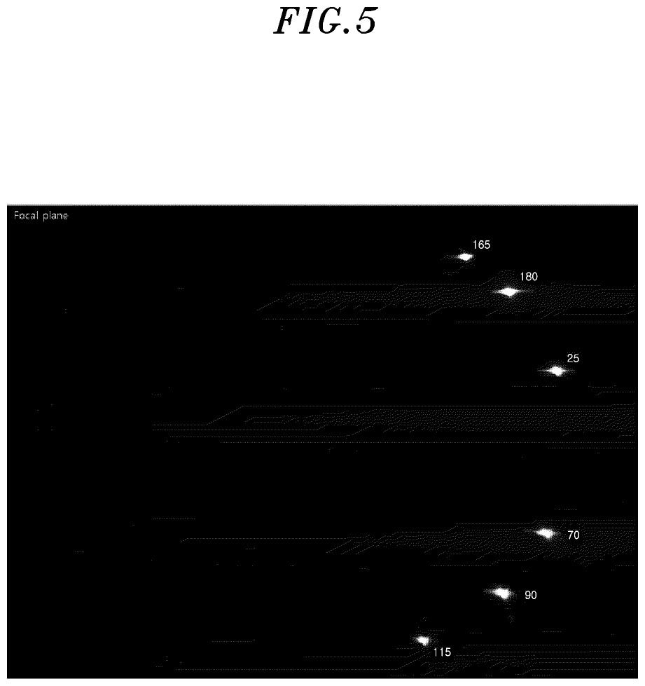

The filter unit 122 may include a plurality of slits 123 longitudinally arranged on one surface, that is, the surface on which the multiple diffracted lights are incident. Accordingly, the multiple diffracted lights, which are incident on the filter unit 122 as shown in FIG. 4, may selectively pass through the plurality of slits 123 in the filter unit 122 so that only lights at specific positions pass through the filter unit 122 as shown in FIG. 5 to be output as the first incident light IL1 to the third incident light IL3.

Meanwhile, the positions or opening/closing of the plurality of slits 123 in the filter unit 122 may be controlled by the operation control unit 124, and as a result, the incident angles of the diffracted lights passing through the filter unit 122, i.e., the first incident light IL1 to the third incident light IL3, can be changed.

For example, the plurality of slits 123 may be configured to move in one direction on one surface of the filter unit 122 or configured to open and close in a shutter-like manner. Accordingly, the operation control unit 124 may change the diffracted lights passing through the plurality of slits 123 by adjusting the positions of the plurality of slits 123 or controlling their opening and closing, thereby changing the incident angles of the first incident light IL1 to the third incident light IL3 output from the filter unit 122.

The operation control unit 124 can generate a grid pattern corresponding to each of the multiple observation regions of the sample 200 and provide it to the wavefront control unit 121 for display. In this case, the operation control unit 124 can control the display spacing of the grid patterns.

In addition, the operation control unit 124 can adjust the positions of the plurality of slits 123 in the filter unit 122 or control the opening/closing of the plurality of slits 123.

The second lens 126 and the third lens 127 may be disposed between the filter unit 122 and the optical unit 130. The second lens 126 and the third lens 127 may cause one or more incident lights output from the filter unit 122, i.e., the first incident light IL1 to the third incident light (IL3), to be focused at different positions on an objective lens 131 of the optical unit 130.

As described above, the incident angle control unit 120 of the present embodiment can generate and output one or more incident lights having different incident angles from the excitation light L1 output from the light emitting unit 110 through one or more grid patterns corresponding to the respective observation regions of the sample 200.

Meanwhile, in the present embodiment, the incident angle control unit 120 has been described as displaying three grid patterns on the wavefront control unit 121 and outputting three incident lights, each having a different incident angle, from the light diffracted through the filter unit 122 as an example. However, the present disclosure is not limited to the above, and for example, three or more grid patterns may be displayed on the wavefront control unit 121, and the filter unit 122 may output three or more incident lights, each having a different incident angle, from the light diffracted through the three or more grid patterns.

That is, the incident angle control unit 120 of the present embodiment can adjust the number of incident lights, each having a different incident angle, provided to the sample 200 through the optical unit 130, which will be described later, by adjusting the number of grid patterns displayed on the wavefront control unit 121, or the positions or opening/closing of the slits 123 in the filter unit 122.

The optical unit 130 may include an objective lens 131, a dichroic mirror 132, and a condenser lens 133.

The objective lens 131 may provide one or more incident lights, i.e., the first incident light IL1, the second incident light IL2, and the third incident light IL3, provided from the incident angle control unit 120 to the sample 200.

As described above, each of the first incident light IL1 to the third incident light IL3 may have a different incident angle with respect to the sample 200 and may be provided to different regions of the sample 200, for example, each of a plurality of observation regions. Accordingly, the first incident light IL1 to the third incident light IL3 may have different depths of penetration into the sample 200.

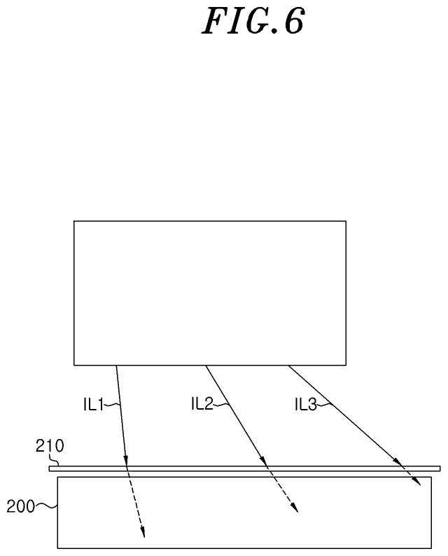

Referring to FIG. 6, a cover glass 210 covering one side of the sample 200 may be disposed between the objective lens 131 and the sample 200. In addition, the objective lens 131 may output at least one of the first incident light IL1 to the third incident light IL3, provided from the incident angle control unit 120, to the sample 200 through the cover glass 210.

The first incident light IL1 may be output to the sample 200 at a first incident angle. In this case, since the first incident angle is smaller than the critical angle, a portion of the first incident light IL1 can be reflected by the cover glass 210, and the remainder can be refracted and provided to the sample 200. Accordingly, the refracted light generated by the first incident light IL1 provided to the sample 200 can penetrate into the sample 200 to a first depth.

In addition, the second incident light IL2 may be output to the sample 200 at a second incident angle. In this case, since the second incident angle is smaller than the critical angle and larger than the first incident angle, a portion of the second incident light IL2 can be reflected by the cover glass 210, and the remainder can be refracted and provided to the sample 200. Accordingly, the refracted light generated by the second incident light IL2 can penetrate into the sample 200 to a second depth. At this time, the second depth may be shallower than the first depth.

Further, the third incident light IL3 may be output to the sample 200 at a third incident angle. In this case, since the third incident angle is greater than the critical angle, most of the third incident light IL3 can be reflected by the cover glass 210. Accordingly, the evanescent field generated by the third incident light IL3 can penetrate into the sample 200 to a third depth. At this time, the third depth may be shallower than the second depth, and may be applied to the surface of the sample 200.

In addition, the objective lens 131 can receive a fluorescence signal FL emitted from the sample 200 by each of the first incident light IL1 to the third incident light IL3.

In this case, when at least two or more incident lights among the first incident light IL1, the second incident light IL2, and the third incident light IL3 are simultaneously provided from the incident angle control unit 120 to the objective lens 131, the objective lens 131 can simultaneously receive two or more fluorescence signals FL generated from fluorescent bodies, e.g., fluorescent particles, located at different depths in the sample 200, in response to each of the two or more incident lights.

In addition, when the first incident light IL1, the second incident light IL2, and the third incident light IL3 are sequentially provided from the incident angle control unit 120 to the objective lens 131, the objective lens 131 can sequentially receive fluorescence signals FL generated from fluorescent particles located at different depths in the sample 200, in response to the respective incident lights.

The dichroic mirror 132 may be disposed between the objective lens 131 and the incident angle control unit 120. The dichroic mirror 132 can reflect light of a specific wavelength, for example, one or more incident lights output from the incident angle control unit 120, toward the objective lens 131. In addition, the dichroic mirror 132 can transmit the remaining light except for the light of the specific wavelength, for example, the fluorescence signals FL emitted from the sample 200, toward the imaging unit 140.

The condenser lens 133 may be disposed between the dichroic mirror 132 and the imaging unit 140. The condenser lens 133 can condense the fluorescence signals FL transmitted through the dichroic mirror 132 and provide them to the imaging unit 140.

A camera 141 of the imaging unit 140 can capture the fluorescence signals FL from the sample 200 output by the optical unit 130 and output a sample image. In addition, a display unit 142 of the imaging unit 140 can display the sample image output from the camera 141, i.e., the sample image including the fluorescence signals FL, to a user through a screen or the like.

As described above, the optical microscope 100 of the present embodiment can generate a plurality of incident lights with different incident angles from a single light output from the light emitting unit 110 through the incident angle control unit 120, and output them to different observation regions of the sample 200, respectively.

Accordingly, the optical microscope 100 of the present embodiment can selectively observe fluorescent particles located at different depths in the sample 200 using a plurality of incident lights to process a single image of the sample 200 at high speed in real time.

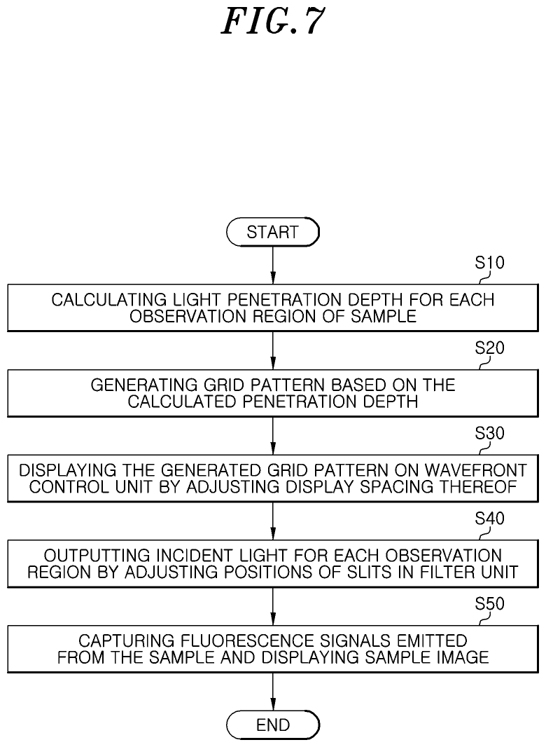

FIG. 7 is a flowchart illustrating a method for controlling the light incident angle of the optical microscope, according to an embodiment of the present disclosure.

Referring to FIG. 7, the incidence angle adjustment unit 120 of the optical microscope 100 may divide a sample 200 into a plurality of observation regions and calculate a light penetration depth for each observation region (S10).

The operation control unit 124 of the incident angle control unit 120 may calculate the light penetration depth for each observation region of the sample 200 based on the following Equation 1.

$$d = \frac{λ}{4} {( {n}_{1}^{2} {sin}^{2} {θ}_{in} - {n}_{2}^{2} )}^{- \frac{1}{2}} \qquad ( Equation 1 )$$

where, d represents the light penetration depth, n₁ represents the refractive index of the cover glass, n₂ represents the refractive index of the sample, θᵢₙ represents the incident angle of light, and λ represents the wavelength of light.

Next, the operation control unit 124 may generate one or more grid patterns based on the calculated penetration depth d (S20).

For example, as shown in FIG. 3, the operation control unit 124 may generate a first grid pattern G1, a second grid pattern G2, and a third grid pattern G3 corresponding to the observation regions of the sample 200, for example, a first region, a second region, and a third region, respectively.

In this case, the first region may be a region where the nucleus of a cell of the sample 200 is located, the second region may be a cell region surrounding the first region of the sample 200, and the third region may be a remaining region of the sample 200 excluding the first region and the second region.

Next, the operation control unit 124 may provide the generated grid pattern to the wavefront control unit 121 so that they are displayed on one surface of the wavefront control unit 121 (S30).

In this case, the operation control unit 124 may calculate the display spacing of the grid pattern based on the following Equation 2 and use this to control the display spacing of the grid pattern displayed on the wavefront control unit 121.

p(sin θᵢₙ+sin θₘ)=mλ (Equation 2)
where, p represents the display spacing of the grid pattern, θᵢₙ represents the incident angle of light, λ represents the wavelength of light, and θₘ represents the diffraction angle of light according to the diffraction order.

Accordingly, the wavefront control unit 121 can simultaneously or sequentially display multiple grid patterns, i.e., the first grid pattern G1 to the third grid pattern G3, under the control of the grid pattern display spacing of the operation control unit 124.

As a result, the wavefront control unit 121 can diffract the light provided from the light emitting unit 110 at multiple angles through the grid patterns displayed on one surface, thereby outputting multiple diffracted lights.

In this case, among the multiple diffracted lights, the diffracted light by the first grid pattern G1 may be light corresponding to the first region of the sample 200, the diffracted light by the second grid pattern G2 may be light corresponding to the second region of the sample 200, and the diffracted light by the third grid pattern G3 may be light corresponding to the third region of the sample 200.

Next, the operation control unit 124 may adjust the positions of the plurality of slits 123 in the filter unit 122. Accordingly, the filter unit 122 can selectively pass some of the multiple diffracted lights provided from the wavefront control unit 121 through the plurality of slits 123 whose positions are adjusted, and output one or more incident lights, for example, the first incident light IL1, the second incident light IL2, and the third incident light IL3 (S40).

According to an embodiment of the present disclosure, when the plurality of slits 123 in the filter unit 122 are configured to have a shutter structure that allows their opening and closing to be controlled, the operation control unit 124 may control the opening/closing of some of the plurality of slits 123 to selectively allow some of the multiple diffracted lights provided from the wavefront control unit 121 to pass through.

In this case, the first incident light IL1 may be light corresponding to the first region of the sample 200, the second incident light IL2 may be light corresponding to the second region of the sample 200, and the third incident light IL3 may be light corresponding to the third region of the sample 200.

In addition, the first incident light IL1 to the third incident light IL3 may have different incident angles with respect to the sample 200. For example, the incident angle of the first incident light IL1 may be smaller than the incident angles of the second incident light IL2 and the third incident light IL3, and the incident angle of the second incident light IL2 may be smaller than the incident angle of the third incident light IL3. Further, the incident angles of the first incident light IL1 and the second incident light IL2 may be smaller than a critical angle, and the incident angle of the third incident light IL3 may be larger than the critical angle.

Then, the objective lens 131 of the optical unit 130 can provide the first incident light IL1 to the third incident light IL3 provided from the incident angle adjustment section 120 to the sample 200. In this case, as described above, since the incident angles of the first incident light IL1 to the third incident light IL3 are different from each other, the penetration depth of each incident light into the sample 200 may be different, as described above with reference to FIG. 6.

Accordingly, the objective lens 131 can receive fluorescence signals FL respectively emitted from fluorescent materials located at different depths in the sample 200, in response to each of the first incident light IL1 to the third incident light IL3, respectively.

The objective lens 131 can provide the received fluorescence signals FL to the imaging unit 140, and the imaging unit 140 can capture the same and display a sample image including the fluorescence signals FL for sample 200 (S50).

As described above, the optical microscope 100 of the present embodiment can generate multiple incident lights with different incident angles from a single light output from the light emitting unit 110 through the incident angle control unit 120, and output them to different observation regions of the sample 200.

Accordingly, in the present disclosure, by providing multiple incident lights with different incident angles for respective observation regions of the sample 200, fluorescent particles located at different depths in the sample 200 can be selectively observed, which enables high-speed processing of an image including fluorescent signals for the sample 200 in real time.

The above description is merely illustrative of the technical idea of the present disclosure, and various modifications and variations may be made by those of ordinary skill in the art to which the present disclosure pertains without departing from the essential quality of the present disclosure. Accordingly, the embodiments disclosed in the present disclosure are intended to explain the technical idea of the present disclosure, not to limit it, and the scope of the technical idea of the present disclosure is not limited by these embodiments. The scope of protection of the present disclosure should be interpreted based on the following claims, and all technical ideas within the equivalent scope thereof should be construed as being included within the scope of the present disclosure.

1. An optical microscope comprising:
a light emitting unit that generates light;
an incident angle control unit that adjusts an incident angle of light emitted from the light emitting unit using a grid pattern corresponding to each of one or more observation regions of a sample, and outputs one or more incident lights with adjusted incident angles; and
an optical unit that outputs the one or more incident lights to the sample.

2. The optical microscope of claim 1, wherein the incident angle control unit includes:
a wavefront control unit that diffracts the light at different angles using the grid pattern displayed on one surface to output multiple diffracted lights;
a filter unit that includes a plurality of slits and selectively passes the multiple diffracted lights output from the wavefront control unit through the plurality of slits to output the one or more incident lights respectively corresponding to the one or more observation regions; and
an operation control unit that calculates a light penetration depth for each of the one or more observation regions of the sample, and generates the grid pattern corresponding to each of the one or more observation regions based on the calculated light penetration depth and outputs the grid pattern to the wavefront control unit.

3. The optical microscope of claim 2, wherein the operation control unit controls a display spacing of the grid pattern displayed on the wavefront control unit.

4. The optical microscope of claim 2, wherein the operation control unit adjusts the incident angle of each of the one or more incident lights by adjusting a position of each of the plurality of slits.

5. The optical microscope of claim 2, wherein the incident angle control unit further includes a plurality of lenses one of which is disposed between the wavefront control unit and the filter unit to focus the multiple diffracted lights output from the wavefront control unit at different locations in the filter unit, and another one of which is disposed behind of the filter unit to focus the one or more incident lights output through the plurality of slits at different locations in the optical unit.

6. The optical microscope of claim 1, wherein the incident angle control unit includes at least one of a MEMS (micro electro mechanical systems) deformable mirror, a liquid crystal spatial light modulator, a digital micromirror, and a phase plate.

7. The optical microscope of claim 1, wherein the one or more incident lights include:
a first incident light having a first incident angle smaller than a critical angle between the optical section and the sample;
a second incident light having a second incident angle smaller than the critical angle and larger than the first incident angle; and
a third incident light having a third incident angle larger than the critical angle.

8. The optical microscope of claim 7, wherein a penetration depth of the first incident light into the sample is greater than a penetration depth of each of the second incident light and the third incident light, and the penetration depth of the second incident light into the sample is greater than the penetration depth of the third incident light.

9. The optical microscope of claim 7, wherein the optical unit simultaneously outputs the first incident light, the second incident light, and the third incident light to the sample.

10. The optical microscope of claim 7, wherein the optical unit sequentially outputs the first incident light, the second incident light, and the third incident light to the sample.

11. A method for controlling a light incident angle of an optical microscope, the method comprising:
calculating a light penetration depth for each of one or more observation regions of a sample;
generating a grid pattern corresponding to each of the one or more observation regions based on the calculated light penetration depth;
outputting multiple diffracted lights by diffracting light emitted from a light emitting unit at different angles based on the grid pattern; and
outputting one or more incident lights by selectively passing some of the multiple diffracted lights corresponding to the one or more observation regions.

12. The method of claim 11, wherein the outputting multiple diffracted lights includes:
displaying the grid pattern corresponding to each of the one or more observation regions on one surface of a wavefront control unit; and
outputting the multiple diffracted lights by controlling a display spacing of the grid pattern.

13. The method of claim 11, wherein the outputting one or more incident lights includes controlling an incident angle of each of the one or more incident lights by controlling a position of each of a plurality of slits in a filter unit.

14. A computer-readable recording medium storing a computer program, wherein the computer program comprises instructions for performing the steps of:
calculating a light penetration depth for each of one or more observation regions of a sample;
generating a grid pattern corresponding to each of the one or more observation regions based on the calculated light penetration depth;
outputting multiple diffracted lights by diffracting light emitted from a light emitting unit at different angles based on the grid pattern; and
outputting one or more incident lights by selectively passing some of the multiple diffracted lights corresponding to the one or more observation regions.
